(19) United States
(12) Patent Application Publication
(10) Pub. No.: US 2013/0280464 A1
(43) Pub. Date: Oct. 24, 2013

(54) FULLY INTEGRATED TOUCH ARTICLES WITH POLYMER EDGE PROTECTION

(71) Applicant: Douglas Miles Noni, JR., Horseheads, NY (US)

(72) Inventor: Douglas Miles Noni, JR., Horseheads, NY (US)

(21) Appl. No.: 13/977,817

(22) PCT Filed: Jan. 6, 2012
(86) PCT No.: PCT/US12/20402

§ 371 Date: Jul. 1, 2013

Related U.S. Application Data
(60) Provisional application No. 61/430,325, filed on Jan. 6, 2011.
(60) Provisional application No. 61/494,126, filed on Jun. 7, 2011.

(51) Int. Cl. B32B 3/08

(52) U.S. Cl. CPC B32B 3/08
USPC 428/38; 156/304.1

(57) ABSTRACT

The application is directed to a product or material or article made of glass where the edge of the glass is protected by the application of a solid pre-formed polymer material that is contained within the thickness of the glass. The protected glass articles have a Figure of Merit in the range of 0.4 to 20, and the edge)s) of the articles have been found to withstand impact velocities of up to 500 mm/sec. The solid pre-formed polymer material that is contained within the thickness of the glass is thus applied to the edge, and it is applied such that it does not protrude into the top and bottom viewable planes, surfaces or faces (the large surface areas) of glass. The solid pre-formed polymer material, the protective material that is contained within the thickness of the glass, may be called herein a “bumper.”

### PRIORITY

This application claims the benefit of priority under 35 U.S.C. §119 of U.S. Provisional Application Ser. No. 61/430,325 filed on Jan. 6, 2011 and U.S. Provisional Application Ser. No. 61/494,126 filed on Jun. 7, 2011 the content of which is relied upon and incorporated herein by reference in its entirety.

### FIELD

The disclosure relates to cover glasses and to Fully Integrated Touch glass applications, to articles used in such applications and a method of making such articles. In particular, the disclosure relates to cover glass and FIT articles that are polymer edge protected.

### BACKGROUND

The disclosure relates to Fully Integrated Touch (“FIT”) applications where a glass substrate is ion-exchanged (“IOX”) at the mother sheet level, electronic elements are applied to the ion-exchanged mother sheet, and the mother sheet having the electronic elements thereon is then cut and finished at the component level to produce a plurality of identical articles from a single mother sheet of glass.

FIGS. 1 and 2 illustrate the “discrete” and “integrated” approaches, respectively, to forming touch panels or articles. In the discrete approach a large mother sheet of cover glass 10 having a selected length, width and thickness is provided. The mother glass sheet 10 is cut and finished in a step 12 to produce a plurality of individual cover glass articles, for example 10a through 101 as illustrated in FIG. 1. The each individual cover glass article of the plurality of articles (for example, glass 10a as shown in FIG. 1) is then ion-exchanged as illustrated by arrow 14 to produce ion-exchanged glass 10aa that can be placed in contact with one face of a touch panel module 16. The other face of the touch panel module 16 is placed in contact with an LCD panel 18 consisting of CF and TFF elements 17 and 19, respectively. Some disadvantages of the discrete approach are that it requires the handling of multiple articles (the cover glass, touch panel module and LD panel), is labor intensive because each cover glass 10a through 101 as illustrated in FIG. 1 must be individually handled and individually ion-exchanged, and the individual articles (cover glass, touch panel module and LCD panel) must be carefully aligned.

The Fully Integrated Touch or FIT approach offers the opportunity of realizing considerable manufacturing advantages and cost savings. In the FIT approach, which is illustrated in FIG. 2, a mother sheet of glass 110 having a length, width and thickness is ion-exchanged in a step 114. The length and width define the faces, a first face and a second face, of the sheet which are separated by the thickness of the glass. The ion-exchanged mother sheet is then subjected to a lithographic process to form a mother sheet having a plurality of touch sensor elements on one face of the ion-exchanged mother sheet of glass. In FIG. 2 the numerals 110a-110l represent the plurality of touch sensor elements on a single mother sheet. After formation of the a mother sheet and the touch elements thereon the mother sheet is cut in a step illustrated by numeral 112 to separate the integrated cover-glass/touch-sensor 115 which consists of, for example a glass part 110a having touch sensor elements 115 on one face of the glass. The integrated article 115 can then be used with the LCD panel 18 as is illustrated in FIG. 2. While the FIT approach offers manufacturing and cost advantages, the problem with this integrated approach is that cutting IOXed glass produces articles have an exposed central tension (“CT”) area at the perimeter of the glass which significantly reduces the strength of the glass. If the exposed CT area is impacted the articles can crack for a distance from the impact area or, if the impact force is large enough, can shatter. Several techniques have been tried to strengthen the edge of the glass. For example, in one approach the glass edges have been acid etched to gain strength. However, these methods have not proved satisfactory. Consequently, it is desirable to find a method of strengthening the edge of FIT articles or components made on and separated from a mother sheet of IOXed glass.

### SUMMARY

In one embodiment the disclosure is directed to a product or material or article made of glass where the edge of the glass is protected by the application of a solid pre-formed polymer material that is contained within the thickness of the glass. The glass article has a length, width and thickness that define a first or top face and a second or bottom face. The glass article further has an edge (for example without limitation, a circular or oval article) or a plurality of edges (for example without limitation, a square, rectangular or hexagonal article), the edge being defined by the thickness of the article. The solid pre-formed polymer material that is contained within the thickness of the glass is thus applied to the edge, and it is applied such that it does not protrude into the top and bottom viewable planes or faces (the large surface areas) of the glass. The solid pre-formed polymer material that is contained within the thickness of the glass may also be called a “guard” or “bumper.” It is important in today's electronics that such guard material does not protrude above or onto the glass surfaces because this is regarded as highly undesirable in terms of aesthetics and tactile performance. In another embodiment the disclosure is directed to a method or process for making a product or material or article made of glass where the edge of the glass is protected by the application of a solid pre-formed polymer material that is contained within the thickness of the glass.

In an embodiment the disclosure is directed to a glass article having a first surface or face and a second surface or face joined by at least one edge and a protective material disposed on at least a portion of the edge, wherein the protective material does not protrude onto either of the first surface or the second surface. The protective material is a solid polymeric material. In an embodiment the protective material is a single piece. In another embodiment the protective material is fluid or paste that can be applied to the edge such that it is contained within the thickness of the glass article and then easily cured to form an edge guard.

In another embodiment the disclosure is directed to an edge protector for an article having a thickness, the edge protector comprising a single piece of polymeric material that is disposable along a periphery of the article and having a thickness that is less than or equal to the thickness of the article. The edge protector is a solid polymeric material.

In a further embodiment the disclosure is directed to a method of protecting an edge of an article, the method having the steps of forming a polymeric edge protector having a thickness that is less than a thickness of the article; and disposing the polymeric edge protector along the edge of the article. The polymeric edge protector may be disposed by bonding the polymeric edge protector to the edge with an adhesive or epoxy. In one embodiment the polymeric edge protector is one-piece shaped article having no free ends and the article is slightly expandable so that it can be fitted on the edge of a glass cover or a glass FIT article.

In a further embodiment the disclosure is directed to a method of protecting an edge of an article, the method having the steps of providing a polymeric fluid or paste having a viscosity such that it does not run off the edge, applying the polymeric fluid to the edge thickness such that the fluid or paste does not contact the surfaces of the article, and curing the polymeric fluid or paste to form a solid resilient polymeric edge guard. The curing can be done by the heating, for example without limitation, but using infrared radiation, particularly mid-range infrared radiation, or by UV curing when the edge guard material is UB curable. The method provides a polymeric edge protector having a thickness in contact with the edge of the article that is less than or equal to the thickness of the article. The polymeric edge protector may be disposed by bonding the polymeric edge protector to the edge with an adhesive or epoxy.

### BRIEF DESCRIPTION OF THE DRAWINGS

FIG. 1 is an illustration of the steps used to make a “discrete” touch article consisting of a cover glass and a touch panel module, and the subsequent combination of the cover-glass/touch-panel to, for example, an LCD panel.

FIG. 2 is an illustration of the steps used to make a “Fully Integrated Touch” or “FIT” article in which a cover glass has a touch sensor formed on one face of the cover glass, and the combination of the FIT article with an LCD panel.

FIG. 3a is a sectional view of the solid pre-formed polymer material or bumper that is contained within the thickness of the glass.

FIG. 3b is an illustration in oblique view of a cover glass or a FIT article in which a solid pre-formed polymer material or bumper has been snapped on to the edges of the cover glass or FIT article, and the edges of the bumper are flush with the top and bottom faces of the cover glass or FIT article.

FIG. 3c is provides an enlarged sectional side view of a cover glass having a bumper applied thereto that illustrates that a bull nose and 45 degree chamfer profiles are sufficient to register or “seat” the solid pre-formed polymer material or bumper.

FIG. 4 illustrate a cover glass article and bumper before (left) and after (right) they are filled together to protect the edges of the glass article

FIG. 5A is a chart illustrating the retained strength after impact of glass articles having a bull nose finish both with edge protection (triangles) and without edge protection (squares).

FIG. 5B is a chart illustrating the retained strength after impact of glass article having a bull nose finish both with edge protection (triangles) and without edge protection (squares).

FIG. 5C is a box plot illustrating edge protection performance with increasing velocity

FIG. 6 is a series of photographs showing impact deformation in edge protection are different impact velocities.

FIG. 7 is a drawing of a bull nosed glass article having a solid pre-formed polymer material or bumper applied to the edge of the article.

FIG. 8 is a side view illustration of a glass article 70 having at least one slot 72 in the thickness of each of the article's edges 73 for receiving a bumper 74 having a tongue 76 corresponding to the slot.

FIG. 9 is a side view illustration of a glass article 80 having at least one convex surface 82 for receiving a bumper 84 having a concave surface 86.

FIG. 10 is a side view illustration of a glass article 90 having at least one saw tooth surface 92 for receiving a bumper 94 having a flat surface 96

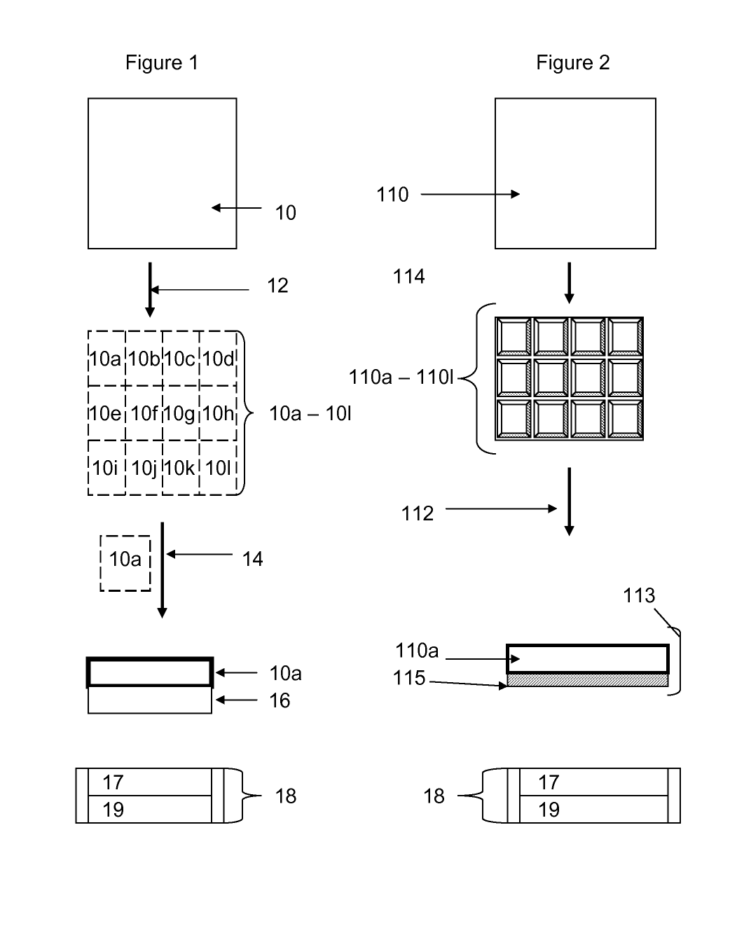

### DETAILED DESCRIPTION

In one embodiment the disclosure is directed to a product or material or article made of glass where the edge of the glass is protected by the application of a solid pre-formed polymer material that is contained within the thickness of the glass. The glass article has a length, width and thickness that define a first or top face and a second or bottom face. The glass article further has an edge (for example without limitation, a circular or oval article) or a plurality of edges (for example without limitation, a square, rectangular hexagonal article), the edge being defined by the thickness of the article. The solid pre-formed polymer material that is contained within the thickness of the glass is thus applied to the edge, and it is applied such that it does not protrude into the top and bottom viewable planes or faces (the large surface areas) of glass.

The solid preformed material can be applied to the edge of the glass by hand or by machine in order to protect the edge from damage. The per-formed polymeric material can be any material that can be slightly expanded for applying the material to the edge as long as such materials provide mechanical cushioning from impacts. An exemplary material is ProtoGen™ O-XT 18420 (available from DSM Somos® (Elgin, Ill.), which is a general purpose, accurate epoxy resin that can be used for stereolithography. ProtoGen™ O-XT 18420 is a high temperature ABS-like photopolymer that can be used to produce accurate RTV patterns, durable concept models, highly accurate parts, and parts that are both humidity and temperature tolerant. Additional exemplary materials are injection molded ABS, polypropylene, and Santoprene™ (Exxon Mobil Chemical) which is a polypropylene and urethane rubber mixture. Furthermore, high modulus material can be used to provide toughness for impact resistance and low modulus materials can be used to provide damping during impact and drop events.

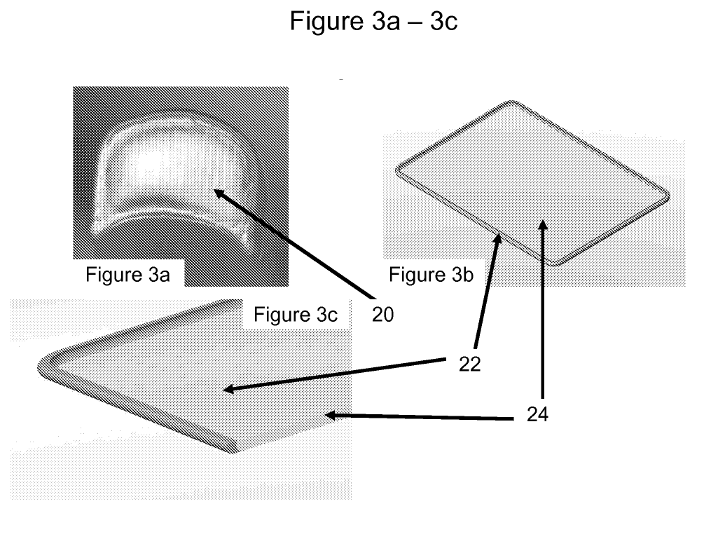

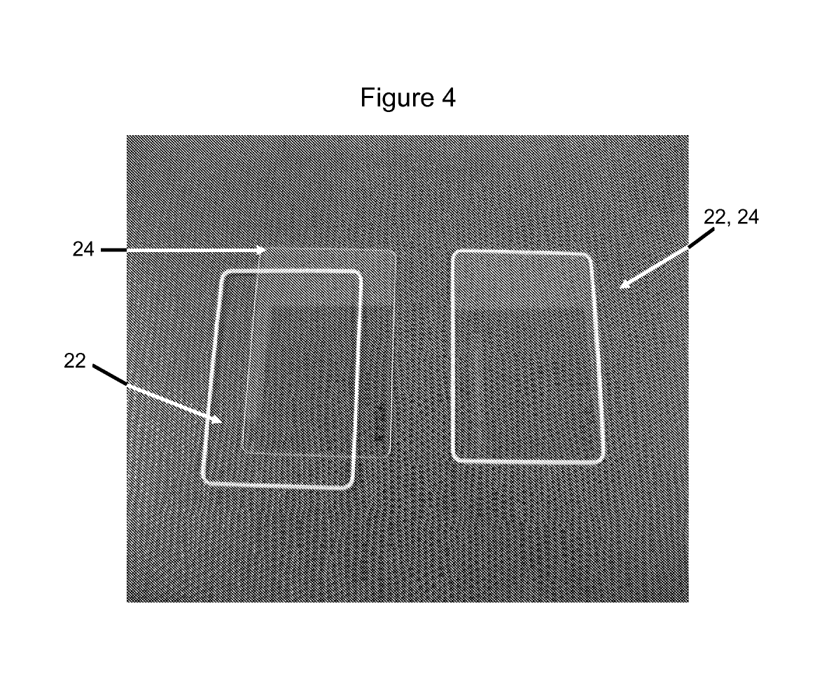

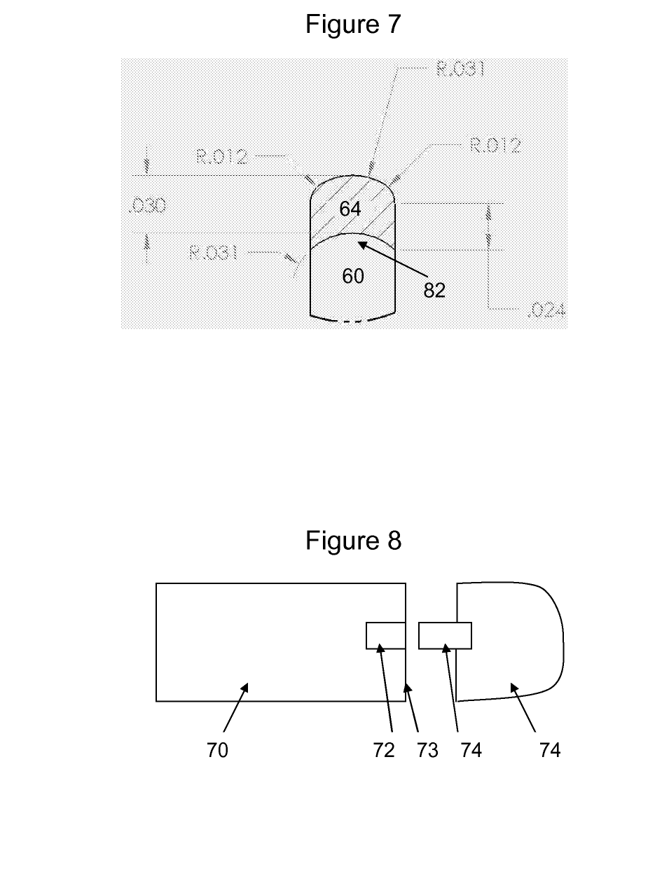

The pre-formed bumpers used herein are produced as slightly expandable, continuous, one-piece parts that can be expanded to fit around the edge of a glass article and will retain their position as fitted. FIG. 3a is a sectional view of the solid pre-formed polymer material or bumper that is contained within the thickness of the glass. The bumper illustrated in FIG. 3a has a profile that will fit the glass edge as further illustrated in FIG. 7. FIG. 3b is an illustration in oblique view of a cover glass or a FIT article in which a solid pre-formed polymer material or bumper has been snapped on to the edges of the cover glass or FIT article, and the edges of the bumper are flush with the top and bottom faces of the cover glass or FIT article. FIG. 3c is provides an enlarged sectional side view of a cover glass having a bumper applied thereto that illustrates that a bull nose and 45 degree chamfer profiles are sufficient to register or “seat” the solid pre-formed polymer material or bumper. FIG. 4 illustrate a cover glass article and bumper before (left) and after (right) they are filled together to protect the edges of the glass article. The continuous, once piece bumper was produced using the ProtoGen™ O-XT 18420 material described above.

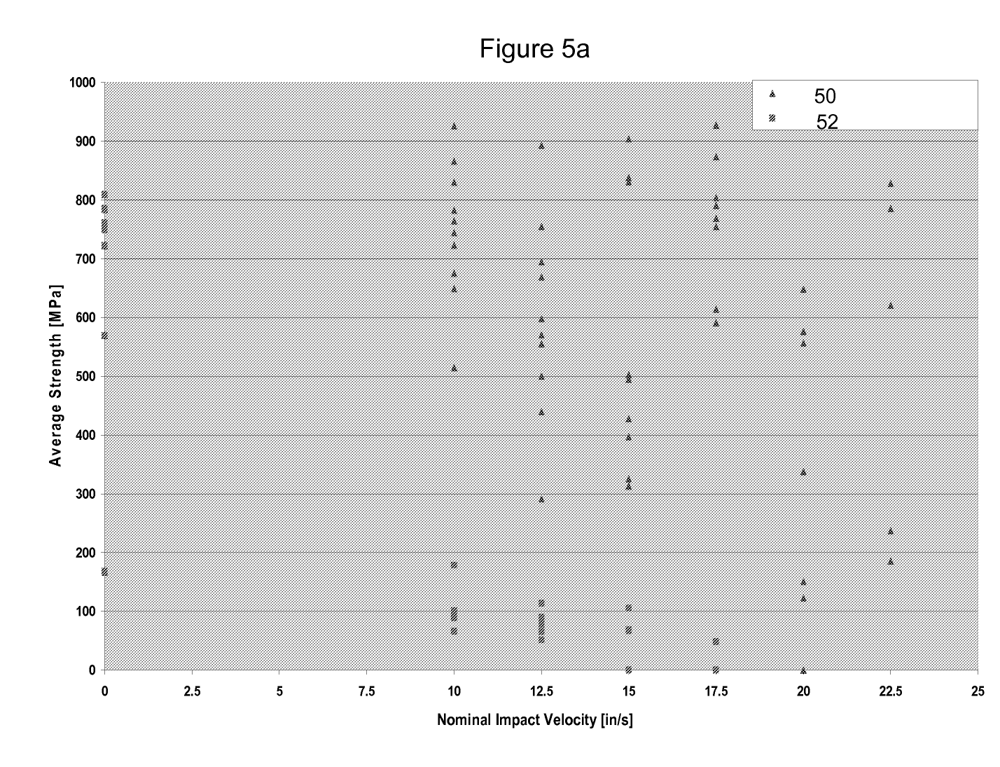

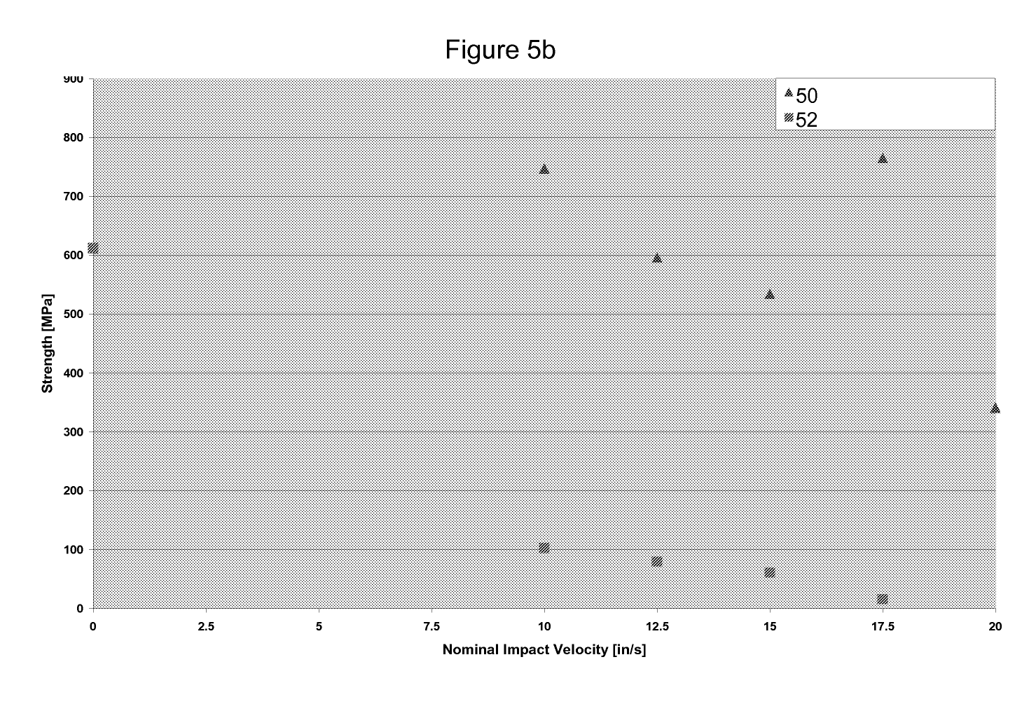

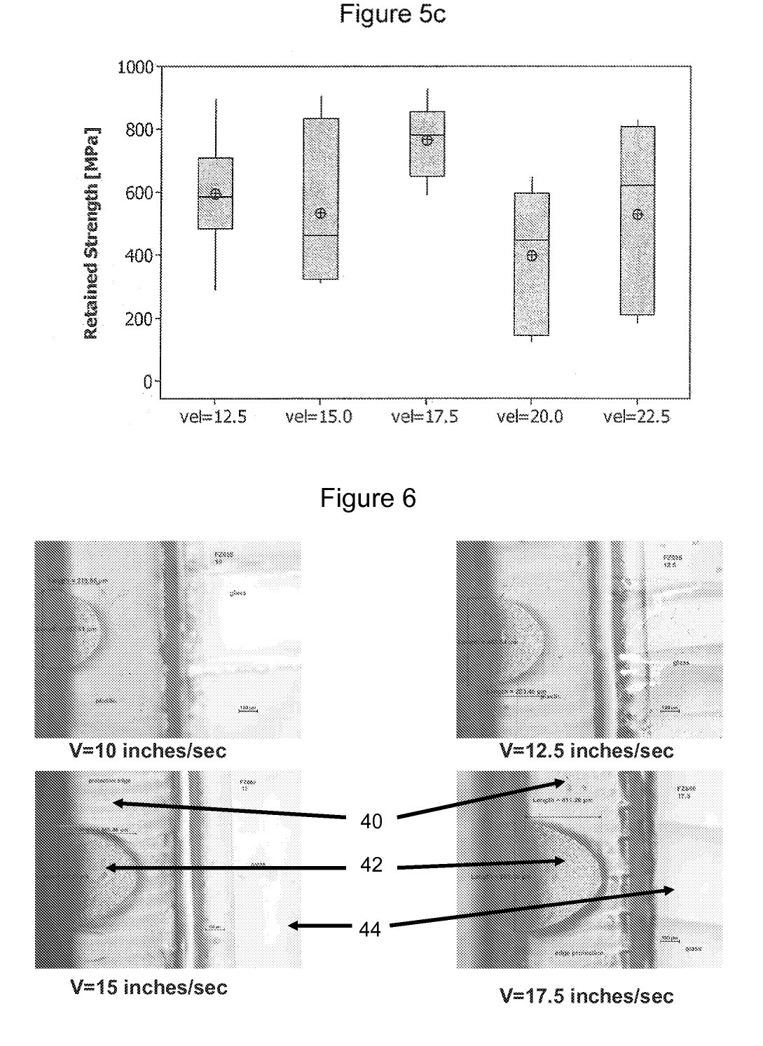

FIG. 5A is a chart illustrating the retained strength after impact of glass articles both with edge protection (triangles 50) and without edge protection (squares 52). All the parts tested were ion-exchanged Corning 2318 aluminosilicate glass having a thickness of 1.1 mm. The glass articles were cut from a mother sheet and then bull nose finished (see FIG. 7). The glass articles that were protected by the bumper as described herein retained ninety percent (90%) of their original edge strength after being impacted at the velocities indicated on the chart because the impact did not reach the glass edge. FIG. 5B is a chart illustrating the average retained strength after impact of glass articles both with edge protection (triangles) and without edge protection (squares). FIG. 5C is a box plot illustrating edge protection by measuring the retained strength of the articles in MPa at different impact velocities. Each box represents the range from the 25^{th} to the 75^{th} percentile with the crossed circle in each box representing the 50^{th} percentile and the horizontal line in each box representing the median retained strength. The data presented in FIGS. 5A-5C clearly indicate the advantages gained using the bumper guards as described herein. FIG. 6 illustrates a glass article 44 having a polymer bumper 42 as described herein after impact (40) with an impacter at velocities of 10, 12.5, 15 and 17.5 inches/sec.

Various methods of protecting a glass edge, for example, those described in US Patent Application Publications 2010-0282260, 2010-285277 and 2010-0221501 as well as other patent or application documents were evaluated and compared to the method described herein. The methods in these other patent or application documents include attempts to protect the glass edge using polymer overmolding (going over the edge of the glass onto the face), a machinable metal armor layer, polymer tapes and liquid polymers, and a shaped fiber such as a glass fiber. Using the same test apparatus as was used to evaluate the polymer edge protection materials and method described herein, none of the prior methods were able to protect the glass or avoid self-destruction/delamination at velocities of >12.5 inches/sec. The polymer overmolding method is undesirable from aesthetic and tactile because the material overlaps on the faces of the article. In contrast, glass articles whose edges were protected according to the present disclosure survived impact testing at an impact velocity of 17.5 inches/sec.

Other materials can also be used could also be used to make the pre-formed polymer edge protection described herein as long as they are capable of being expanded slightly for applying the material to the edge and as long as they provide the mechanical cushioning from impacts. For use in large scale manufacturing quantities parts it may be desirable to make the edge protection material using injection molding or similar techniques. Another possibility is that the edge protection material is manufactured in a roll or strip and is applied to varying glass part sizes by fitting, trimming to length and joining the edges together. Design considerations should also be given to the profile of the protection to account for edge impacts of angles between normal and inclination of angle slightly less than 90 degrees.

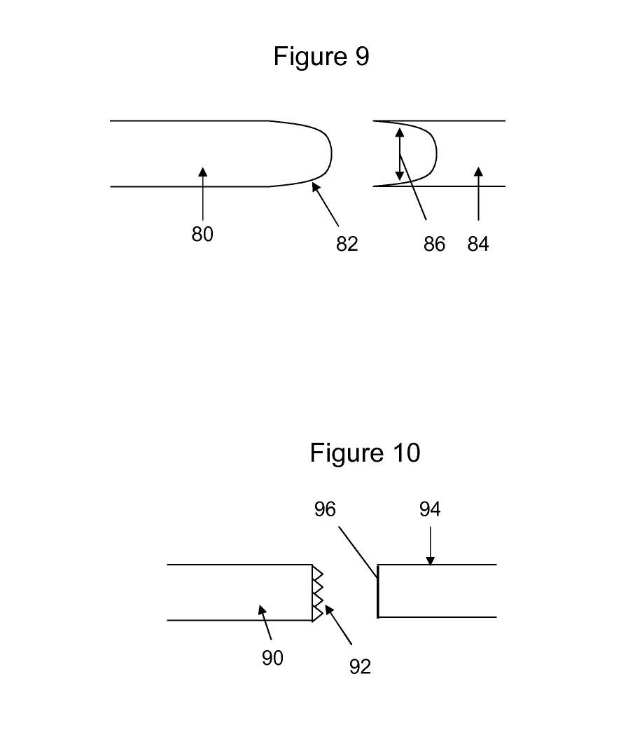

FIG. 7-10 illustrate without limitation, embodiments of the edge that received the bumper as disclosed herein. FIG. 7 is a drawing of a glass article 60 with a bull nose 82 and having a solid pre-formed polymer material or bumper 64 having a shaped recessed surface 66 applied to the edge 62 of the article 60. FIG. 7 also illustrates radii of curvature R and several dimensions between glass and bumper surfaces, in inches, as illustrated. FIG. 8 is a side view illustration of a glass article 70 having at least one slot 72 in the thickness of each of the article's edge(s) 73 for receiving a bumper 74 having a tongue 76 corresponding to the slot. FIG. 9 is a side view illustration of a glass article 80 having at least one convex surface 82 for receiving a bumper 84 having a concave surface 86. The difference between FIGS. 7 and 9 is in the “nose of the glass and the bumper surface for receiving the nose are more elongated in FIG. 9 relative to the shorted and stubbier bull nose of FIG. 7. FIG. 10 is a side view illustration of a glass article 90 having at least one saw tooth surface 92 for receiving a bumper 94 having a flat surface 96.

Table 1 gives the Figure of Merit for glass articles having edge protection as described herein. A Figure of Merit (“FOM”) is a quantity that can be used to characterize the performance of a device, system or method relative to its alternatives. In engineering and materials science Figures of Merit are often defined for particular materials or devices in order to determine their relative utility for an application. In the present case Equation 1 was used to calculate the FOM for glass articles having an edge protection as described herein.

$$F O M = \frac{( glass thickness ) \times ( glass weight ) \times ( velocity )}{thickness of the edge protection} \qquad Eq . 1$$

For glass articles that are edge protected according to this disclosure, the FOM is to be in the range of 0.4 to 20 for glass having a length in the range of 50 mm to 120 mm, a width in the range of 30 mm to 60 mm, and a thickness in the range of 0.4 mm to 1.2 mm for edge protected glass articles tested at velocities in the range of 300 mm/sec to 525 mm/sec and the edge protection being in the range of 450 μm to 800 μm. Table 1 gives FOM values, calculated using Eq. 1, for glass samples that have edge protectors with a thickness of 500 μm and 700 μm.

TABLE 1
Figure of Merit values

| | | | Velocity | | |
|---|---|---|---|---|---|
| Sample | t (mm) | Wt (g) | mm/sec (in/sec) | EPT (μm) | FOM |
| 1* | 1.1 | 7 | 317.5 (12.5) | 750 | 3.26 |
| 2 | 1.1 | 5 | 317.5 (12.5) | 750 | 2.33 |
| 3 | 0.7 | 5 | 317.5 (12.5) | 750 | 1.46 |
| 4 | 1.1 | 5 | 431.8 (17.5) | 750 | 4.43 |
| 5 | 1.1 | 5 | 431.8 (17.5) | 500 | 6.65 |
| 6 | 0.55 | 3.5 | 431.8 (17.5) | 500 | 1.66 |
| 7 | 0.55 | 3.5 | 317.5 (12.5) | 750 | 0.81 |
| 8 | 0.55 | 3.5 | 431.8 (17.5) | 750 | 1.11 |
| 9* | 1.1 | 7 | 508 (20) | 750 | 5.22 |
| 10 | 1 | 15 | 508 (20) | 750 | 9.75 |
| 11 | 1.1 | 15 | 508 (20) | 500 | 16.76 |
| 12 | 0.55 | 3.5 | 317.5 (12.5) | 750 | 0.81 |

1. Samples 1-9 have a length L and width W of 60 mm × 40 mm, respectively.
2. Samples 10 and 11 have a length L and a width W of 57 mm and 105 mm, respectively.
3. T = thickness of the glass sample.
4. Wt = the weight of the glass sample in grams.
5. Velocity = the velocity at impact of the sled carrying the sample mm/second.
6. EPT = edge protector thickness, from glass surface to the outer edge of the protector.
7. Glass density, calculated from sample weight and volume, is 0.00242 g/mm³.
8. The “*” symbol indicates actual FOM test results. Other FOM values were calculated.

Table 1 provides actual and predictive results in terms of a Figure of Merit. In term of the actual “force at impact,” the heaviest glass article with the fastest velocity and with the thinnest edge protection will have the highest probability being damaged. Conversely, the lightest glass article at the slowest velocity and the thickest edge protection will have the least probability of being damaged. Excluding Samples 10 and 11, in which the glass weighs 15 grams, Sample 9 is representative of the heaviest tested glass articles (1.1 g) at the fastest velocity (750 mm/sec), but with an edge protection of 750 μm. The FOM for this glass is 5.22. Sample 1 is an identical glass article in terms of weight and edge protection thickness, but it was tested at a velocity of 317.5 mm·sec, and has a FOM of 3.25. These results, particularly when viewed in term of the “Retained Strength vs. Nominal Impact Velocity” graphs of FIGS. 5A and 5B suggest that glass articles having a FOM in the range of 0.4 to 20 will be protected from damage.

In addition, the protective edges as described herein and the method of making them can be applied to any glass article and further is not restricted to the type of glass being used. The glass can be silica, fused silica, borosilicate, alkali borosilicate, aluminosilicate, alkali alumino silicate, soda lime, silica-titania, or chalcogenide glasses, or other glasses known in the art. The glasses can be ion-exchanged or not ion-exchanged. The method can also be used to make glass-ceramic and ceramic articles having edge protection as described herein. In one embodiment articles having the edge protection described herein are transparent glass-ceramics.

The edge protection data shown in the Figures was obtained by having the edges of the edge-protected and non-edge protected articles impact a knife blade at the velocities recited herein. The test can be carried out by either moving the article to contact the knife blade or moving the knife blade to contact the articles. The former method was used herein.

Thus, disclosed herein is a glass article, or a transparent glass-ceramic article, having a first surface and a second surface, both having a selected length and a selected width, and a selected thickness between the surfaces, the thickness defining edge(s) of the article, and a polymeric protective material disposed on said edge(s); wherein the protective material does not protrude onto either of the first surface or the second surface, and the article has a Figure of Merit in the range of 0.4 to 20. The glass length is in the range of 50 mm to 120 mm, the width is in the range of 30 mm to 60 mm and the thickness is in the range of 0.4 mm to 1.2 mm, and the glass can be a glass as cited herein that has been ion-exchanged or not ion-exchanged. In one embodiment the protective material is a continuous piece of polymeric material surrounding the edges of the article. In an embodiment the edge(s) of the glass article is a shaped edge, the shapes being selected from the group consisting of bull nose, chamfered, rounded, saw toothed, convex and textured. In one particular embodiment the edge(s) of the article are flat and edge(s) has at least one slot therein, and said article has an edge protector with corresponding tongues that are fitted into said slot. In another particular embodiment the edge(s) of the article are convex and said article has an edge protector with corresponding concave surface thereto.

Also disclosed herein is a method of protecting an edge of a glass article, the method comprising providing a glass article having a first surface and a second surface, both having a selected length and thickness, and a selected thickness defined by the surfaces, the thickness defining the edge(s) of the article; forming a polymeric edge protector having a thickness that is less than a thickness of the article; and disposing the polymeric edge protector along the edge of the article such that the edge protector does not protrude onto either the first surface or the second surface to thereby form an edge protected glass article. The protected glass article has a Figure of Merit in the range of 0.4 to 20. In an embodiment the provided polymeric edge protector is one continuous piece, and is disposed along the edge(s) and held in place by elastomeric forces. In another embodiment the provided polymeric edge protector adhesively bonded to the edge(s) of to the edge with an adhesive or epoxy. In an embodiment the provided glass article has a length in the range of 50 mm to 120 mm, a width in the range of 30 mm to 60 mm and a thickness in the range of 0.4 mm to 1.2 mm. Further, the provided glass article is a shaped edge, the shapes being selected from the group consisting of flat, bull nose, chamfered, rounded, saw toothed, convex and textured.

While typical embodiments have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of this disclosure or the appended claims.

I claim:

1. A glass article having a first surface and a second surface, both having a selected length and width, and a selected thickness between the surfaces, the thickness defining edge(s) of the article, and a polymeric protective material disposed on said edge(s),
wherein the protective material does not protrude onto either of the first surface or the second surface, and
the article has a Figure of Merit in the range of 0.4 to 20.

2. The glass article of claim 1, wherein the glass length is in the range of 50 mm to 120 mm, the width is in the range of 30 mm to 60 mm and the thickness is in the range of 0.4 mm to 1.2 mm.

3. The glass article of claim 2, wherein the protective material is a continuous piece of polymeric material surrounding the edges of the article.

4. The glass article according to claim 1, wherein the edge(s) of the glass article is a shaped edge, the shapes being selected from the group consisting of bull nose, chamfered, rounded, saw toothed, convex and textured.

5. The glass article according to claim 1, wherein the edge(s) of the article are flat and edge(s) has at least one slot therein, and said article has an edge protector with corresponding tongues that have been fitted into said slot.

6. The glass article according to claim 1, wherein the edge(s) of the article are convex and said article has an edge protector with corresponding concave surface thereto.

7. The glass article according to claim 1, wherein the glass is selected from the group consisting of silica, fused silica, borosilicate glass, aluminosilicate glass, aluminoborosilicate glass, soda lime glass, silica-titania glass and chalcogenide glass, and said glasses being ion-exchanged or not ion-exchanged.

8. A method of protecting an edge of a glass article, the method comprising:
providing a glass article having a first surface and a second surface, both having a selected length and thickness, and a selected thickness defined by the surfaces, the thickness defining the edge(s) of the article,
forming a polymeric edge protector having a thickness that is less than a thickness of the article; and
disposing the polymeric edge protector along the edge of the article such that the edge protector does not protrude onto either the first surface or the second surface to thereby form an edge protected glass article having a Figure of Merit in the range of 0.4 to 20.

9. The method of claim 8, wherein the polymeric edge protector is one continuous piece, and is disposed along the edge(s) and held in place by elastomeric forces.

10. The method according to claim 8, wherein the polymeric edge protector adhesively bonded to the edge(s) of to the edge with an adhesive or epoxy.

11. The method according to claim 8, wherein the provided glass article has a length in the range of 50 mm to 120 mm, a width in the range of 30 mm to 60 mm and a thickness in the range of 0.4 mm to 1.2 mm.

12. The method according to claim 8, wherein the edge of the provided glass article is a shaped edge, the shapes being selected from the group consisting of flat, bull nose, chamfered, rounded, saw toothed, convex and textured.
